(19) United States
(12) Patent Application Publication
(10) Pub. No.: US 2008/0105624 A1
(43) Pub. Date: May 8, 2008

(54) Method for Oxidative Treatment of Aqueous Liquids

(76) Inventor: Hans Wormcke, Wedel (DE)

Correspondence Address: MEREK, BLACKMON & VOORHEES, LLC, 673 S. WASHINGTON ST, ALEXANDRIA, VA, 22314, US

(21) Appl. No.: 11/667,764

(22) PCT Filed: Jul. 25, 2006
(86) PCT No.: PCT/EP06/07362

§ 371 Date: May 15, 2007

(30) Foreign Application Priority Data
Aug. 26, 2005 (DE) 10 2005 040 367.0

(51) Int. Cl. B01D 35/06

(52) U.S. Cl. 210/748

(57) ABSTRACT

The invention relates to a method for oxidative treatment of aqueous liquids by means of oxidants. In this method, the aqueous liquid is passed through an electrolysis reactor, in which highly aggressive oxidants (OH^{—}, O₃, H₂ O₂) are produced in the electrochemical decomposition of the water. Black and/or grey water is used as the aqueous liquid, which is liberated from coarse particles and mechanically broken up thereafter, before it is passed into the electrolysis reactor. Gaseous portions are released and inorganic residual components are filtered out. The remaining residual liquid, which consists substantially of water, can be introduced into a fresh, wash- and/or rinse water system.(only FIGURE)

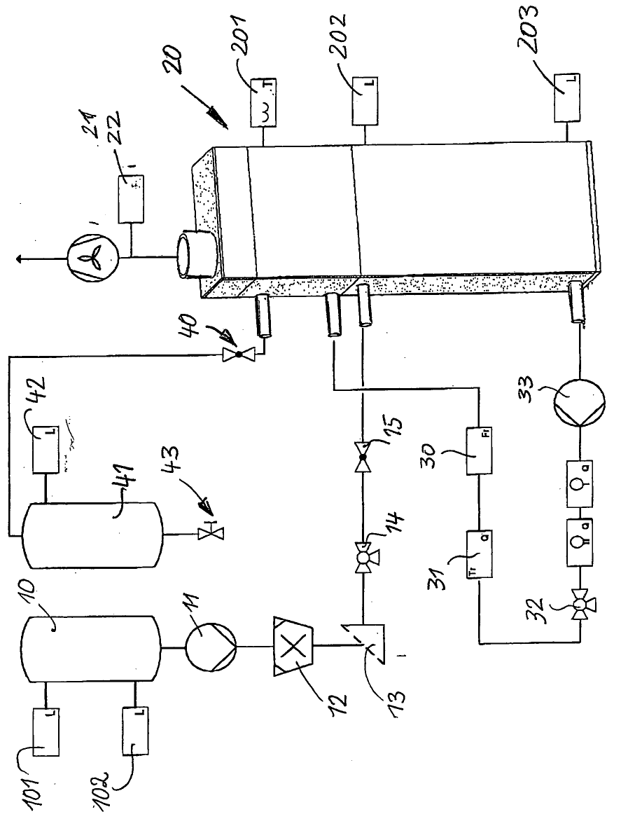

The invention relates to a method for oxidative treatment of aqueous liquids by means of oxidants, wherein the aqueous liquid is passed through an electrolysis reactor, in which such electrodes are utilised, which produce mainly highly aggressive oxidants (OH^{—}, O₃, H₂O₂) in the electrochemical decomposition of the water due to high excess voltages (for example +3V at the anode and −1.5V at the cathode).

A method for oxidative treatment of surfaces by means of an electrolyte liquid containing oxidants is known (DE 102 19 688 A1). In this an electrolyte liquid is pumped in circulation. The required oxidants are electrochemically produced by means of electrodes provided with a diamond cover in an electrolysis reactor. Such electrodes have the property to produce a large potential difference between cathode and anode in the electrolysis, which clearly exceeds the usual 1.4 Volt and can be about 4.5 Volt, for example. In this, mainly very aggressive hydroxyl radicals are created, but also ozone and hydrogen peroxide. The known method is utilised in order to clean the surfaces of silicon wafers, for example, and for this purpose the wafers are put into a container with an electrolytic liquid such as sulfuric acid.

The present invention relates to a method for oxidative treatment of black and/or grey water such that an end product can be produced, which consists substantially of water.

The term black water is to be understood in this application as faeces in more or less liquid form. The water originating for example from a hand wash basin has been designated as grey water.

The water treated according to the method of the invention is designated as rinse or wash water, that is water, which can be used for flushing in a toilet. According to the method of the invention the black and/or grey water can be conditioned to such an extent, though, that is can certainly be used as fresh water, if one does not consider the slight chloride portions contained therein, in which respect the utilisation as washing water in toilets in trains or air-planes is envisioned here.

Starting from the known method, black or grey water is used as the aqueous liquid according to the invention, this is freed from coarse particles, mechanically broken up thereafter, before being passed into the electrolysis reactor, in order to be able to release gaseous portions, and to introduce the remaining residual liquid, which consists mainly of water, into a fresh, wash and/or rinse water system.

In a preferred method according to the invention, a circulating method can be utilised, that is the liquid to be treated is passed several times through the electrolysis reactor such that this can be formed relatively small depending on the arising liquid volume to be treated. It is conceivable equally well though, to utilised a non-continuous method here, that it to dimension the length of the electrolysis reactor such that the liquid to be treated is conditioned during passing through the electrolysis reactor that far that a liquid can be taken out at the outlet, which consists substantially of water.

The invention is explained below by way of example with reference to the only FIGURE of the drawing, wherein this shows a flow diagram of the conditioning of black water into fresh water.

In the FIGURE, a black water tank is indicated by 10, wherein for example the discharge mass from a toilet or from a water basin in a toilet on a plane or on a train is collected. In this connection it is not substantial, how the discharge mass is conveyed there, that is via the usual devices in domestic installations or via vacuum devices, as they are known in vacuum toilets in vehicles.

101 and 102 designate the level indicators of the tank.

A black water pump 11 conveys the discharge mass into a shredder 12, in which the discharge mass is broken up. From here the discharge mass passes into a filter 13 and through a discharge valve 14 and an inlet valve 15 into the electrolysis reactor 20.

Not shown in the FIGURE is a separator, which can be arranged anywhere between the toilet and the black water tank 10, in order to remove such parts from the accumulating liquid, which are not to be subjected to the treatment. Here parts such as lighters are sorted out, which sometimes end up in the bowl of a toilet.

Located in the electrolysis reactor 20 is a plurality of diamond covered electrodes, and, as far as both electrodes, cathode and anode, are covered with carbon, a separating cloth membrane is arranged between them. It is substantial for the present invention that such electrodes are selected, which produce a relatively high voltage difference, of which it is known that especially OH^{—} radicals are produced. These are generated from the aqueous portion of the faeces or of the wash and grey water, respectively, and in turn affect the other components of the wash and grey water in oxidising manner. These components are almost exclusively organic compounds, which are converted through the OH^{—} radical to water and carbon dioxide. This is the process desired according to the invention, namely, that the oxidants can be produced from the aqueous components of the faeces, which in turn “burn” the organic components of the faeces such that besides water only carbon dioxide remains.

The faeces are guided into a cycle, that is, they exit the electrolysis reactor 20 and via flow and transmission flow measurements, determination of the reduction or oxidation, respectively, and of the pH value (30, 31, 32) they are passed into the reactor 20 again. For the circulation of the liquid a rotary pump 33 is utilised. In the FIGURE the inlet of the reactor 20 is arranged at the top and the outlet at the bottom, although in a preferred method according to the invention this is also implemented in reversed manner.

Not shown in this cycle of the elements 20, 30, 31, 32 and 33 is a bypass with a filter, which bypass can be switched in and out. This filter is utilised to filter out not transformed components, that is for example organic components, which can also occur in faeces in low amounts.

The reactor 20 is provided with level indicators 202, 203 and a temperature meter 201.

Furthermore, the reactor 30 has an outlet for exhaust air guided upwards, which is led out of the device by means of an exhaust air vent 21 controlled through an air flow monitor 22.

When the circulating liquid has been treated sufficiently long, it can be guided through an outlet valve 40 into a fresh water tank 41. This is provided with a level indicator 42. Fresh water can be withdrawn through a valve 43.

In a preferred use of the method according to the invention, such as in a train toilet, it can be achieved that the fresh water required for flushing the toilet can be recovered. The treated fresh water obtained above that can be discharged onto the rails without any problem.

Essential is in this connection the closed cycle, i.e. that arising black water is circulated therein that long, until is has achieved the required quality.

1. Method for oxidative treatment of aqueous liquids by means of oxidants, wherein the aqueous liquid is passed through an electrolysis reactor, in which electrodes are utilised, which due to high excess voltages (for example +3 at the anode and −1.5 V at the cathode) mainly produce highly aggressive oxidants (OH^{—}, O₃, H₂O₂) in the electrochemical decomposition of the water, characterised in that black and/or grey water is used as the aqueous liquid, this is liberated from coarse particles in a separator, is mechanically broken up thereafter, before it is passed into the electrolysis reactor, gaseous portions are released and inorganic residual components are filtered out, and that the remaining residual liquid, which consists substantially of water, is introduced into a fresh, wash and/or rinse water system.
